(19) United States
(12) Patent Application Publication
(10) Pub. No.: US 2005/0057021 A1
(43) Pub. Date: Mar. 17, 2005

(54) Wheelchair useable as walking stick

(76) Inventor: Etsuo Miyoshi, Higashikagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/940,955

(22) Filed: Sep. 15, 2004

(30) Foreign Application Priority Data
Sep. 16, 2003 (JP) 923718/2003

(51) Int. Cl. B62B 9/00; B62M 1/14

(52) U.S. Cl. 280/657; 280/250.1

(57) ABSTRACT

A wheelchair usable as a walking stick comprises a collapsible chair can be collapsed in the direction that both elbow rests approach each other; a pair of large wheels which are rotatably attached to both the rear outsides of the collapsible chair; a pair of freely moving wheels which are located in both the fore sides of the collapsible chair; vertical rods which are fastened to the rear side of the collapsible chair in vertical posture; and grips, which are fastened so as to extend frontward at the top ends of the vertical rods, with at least their fore ends positioned frontward of the rotation shafts of the pair of large wheels and rearward of the freely moving wheels. In the wheelchair, the wheelchair can be moved as a walking stick by grasping the grips, and rotating the large wheels and the freely moving wheels in the state where the collapsible chair is collapsed so that the elbow rests approach each other.

### BACKGROUND OF THE INVENTION

The present invention relates to a wheelchair usable as a walking stick.

Wheelchairs are used for persons with gait disorder. However, wheelchairs are not always used for persons who cannot walk, but are also used for persons with light disorder who get fatigued easily due to the disorder when walking. The person with light disorder does not always move in wheelchairs, but they walk while pushing the wheelchairs. In this case, conventional wheelchairs have a disadvantage that they cannot walk comfortably.

A conventional wheelchair is designed to be easily moved by pushing the backside of the wheelchair in the state that a person with disorder sit on a chair portion. Grips, which extend rearward, are fastened to the top end of vertical rods, which are fastened on the both sides of backrest to be used in such a manner. Thus, the wheelchair can be easily moved by pushing it with grasping the grips.

Since the wheelchair of this structure is designed to be moved in the state that a user sits on a chair portion, it has a disadvantage that cannot be stably moved when a user does not sit on the chair portion. Particularly, the wheelchair has a disadvantage that becomes very unstable when moved by pushing with putting user's weight on its grips. The reason is that the grips are positioned rearward of large wheels. When putting user's weight on the grips positioned in this arrangement, the front of the wheelchair leaves from the ground, thus the wheelchair cannot be stably moved.

A walking stick does not have a wheel at its lower end. The walking stick can bear walker's weight without slipping of the lower end. However, with a typical walking stick, when walking, a user walks ahead while frontwardly moving its lower end away from the ground. This walking stick cannot bear the walker's weight, when its lower end leaves away from the ground. This walking stick has a disadvantage that cannot continuously bear the weight. When a caster is fastened to the lower end of a walking stick, it is not necessary to leave the lower end from the ground. Accordingly, such a walking stick can continuously bear the weight. However, in the structure where a caster is fastened to the lower end of one walking stick, the lower end of the walking stick moves with the caster. Thus, such a walking stick cannot firmly bear weight.

A waking aid is used as a device that can firmly bear the weight instead of a walking stick. Although a typical waking aid is large, and a place, where such a waking aid can be used, is limited, Japanese Laid-Open Publication Kokai No. HEI 9-38161 (see Patent Document 1) discloses a compact waking aid, which can be conveniently used. In the waking aid disclosed in this Publication, as shown in FIG. 1, four casters 51 are fastened to the lower end of a frame 52 bent in a U-shape. In order for the frame 52 to stand on its own, legs 53, which extend in the transverse direction, are fastened to the lower ends of the frame 52. Casters 51 are fastened to the both ends of each leg 53.

Patent Document 1: Japanese Laid-Open Patent Publication TOKUKAI No. HEI 9-38161

The waking aid disclosed in this Publication is provided with a collapsible chair 54 in the middle of the frame 52, as shown in FIGS. 1 and 2. In addition, a basket 55 is connected to the top on one side. The waking aid of this structure stands on its own with the four casters 51, and can bear the weight. Since the chair is provided, a user can sit on the chair at rest. However, with this waking aid, a user cannot move in the state of sitting on the chair, dissimilarly to a wheelchair. Accordingly, when a user who moves in a wheelchair uses a walking stick, he or she should carries both the walking stick and the wheelchair. However, actually, even a person with light disorder cannot carry both the wheelchair and the walking stick. Particularly, in the case of the large walking stick with the four casters fastened to its lower end, it is impossible to carry both the walking stick and the wheelchair.

### SUMMARY OF INVENTION

The present invention has been developed for solving the disadvantages. It is an important object to provide a wheelchair, which can be used as a walking stick stably bearing user's weight, capable of being used very conveniently.

To achieve the foregoing object, a wheelchair usable as a walking stick of the present invention has the following construction. The wheelchair of the present invention comprises a collapsible chair which has elbow rests on both its sides and can be collapsed in the direction that both the elbow rests approach each other; a pair of large wheels which are rotatably attached to both the rear outsides of the collapsible chair; a pair of freely moving wheels which can be freely moved in any moving directions and are located in both the fore sides of the collapsible chair; vertical rods which are fastened to the rear side of the collapsible chair in vertical posture; and grips, which are fastened so as to extend frontward at the top ends of the vertical rods, with at least their fore ends positioned frontward of the rotation shafts of the pair of large wheels and rearward of the freely moving wheels. In the wheelchair, the wheelchair can be moved as a walking stick by grasping the grips, and rotating the large wheels and the freely moving wheels in the state where the collapsible chair is collapsed so that the elbow rests approach each other.

The wheelchair of the present invention may have a structure where the vertical rods are extensible, and include a stopper which can hold that the vertical rods are extended. In the wheelchair, the height of the grips is 60 to 100 cm in the state where the vertical rods are extended. In addition, in the wheelchair of the present invention, a brake may be provided on the large wheel, and the grip may have a lever for operating the brake. Moreover, in the wheelchair of the present invention, the vertical rod is located in the position that extends upward from the rotation axis of the large wheel.

The above wheelchair has an advantage that can be used as a walking stick, which can stably bear walker's weight in the state where the collapsible chair is collapsed. In particular, the wheelchair has an advantage that can move with bearing the weight more stably and move in the state where the collapsible chair is not collapsed, or unfolded. The reason is that, in the wheelchair, the grips are fastened so as to extend frontward at the top ends of the vertical rods, and their fore ends are positioned frontward of the rotation shafts of the large wheels and rearward of the freely moving wheels. With the grips positioned between the large wheel and the freely moving wheel, when a user walks with grasping the grips, in the case where a vertical load is applied in order to bear weight, the vertical load is applied in the middle between the large wheel and the freely moving wheel. Accordingly, both the large wheel and the freely moving wheel bear the vertical load in good balance. Therefore, the vertical load does not act in the direction that tilts the wheelchair. In addition, in the wheelchair of the present invention, the wheelchair can be used as a walking stick, in the state where its width is narrow by collapsed so that the elbow rests approach each other. Since, when the wheelchair is used as a walking stick in this state, its width becomes very narrow, the wheelchair has an advantage that can smoothly move in a narrow place or a crowded place. Furthermore, since the wheelchair of the present invention is provided with the freely moving wheels frontward of the large wheels, the wheelchair has an advantage that can stably move in the desired direction by pushing the walking stick. Moreover, in the present invention, since the wheelchair is used as a walking stick, it is not necessary to carry both a wheelchair and a walking stick. There is an advantage that a user can move in the wheelchair, or walk in the state where the wheelchair bears user's weight depending on a use place and use conditions.

The above and further objects and features of the invention will be more fully apparent from the following detailed description with the accompanying drawings.

### BRIEF DESCRIPTION OF THE DRAWINGS

FIG. 1 is a perspective view showing an example of a conventional waking aid;

FIG. 2 is a front view showing the waking aid shown in FIG. 1 in use;

FIG. 3 is a perspective back view of a wheelchair usable as a walking stick according to one embodiment of the present invention;

FIG. 4 is a front perspective view showing the collapsed wheelchair usable as a walking stick shown in FIG. 1;

FIG. 5 is a cross-sectional view schematically showing an uncollapsed collapsible chair of the wheelchair;

FIG. 6 is a cross-sectional view schematically showing the collapsed collapsible chair of the wheelchair;

FIG. 7 is a perspective back view showing a seat surface portion and a collapsible link in the uncollapsed collapsible chair;

FIG. 8 is an enlarged side view showing a connection portion of a footrest frame;

FIG. 9 is an enlarged transverse cross-sectional view showing an example of a large wheel;

FIG. 10 is an enlarged transverse cross-sectional view showing another example of the large wheel;

FIG. 11 is an enlarged transverse cross-sectional view showing another example of the large wheel;

FIG. 12 is an enlarged cross-sectional view showing the structure of a stopper of an extensible rod;

FIG. 13 is an enlarged cross-sectional view showing the extensible rod shown in FIG. 12 with the stopper disengaged; and

FIG. 14 is a schematic view showing the wheelchair with a vertical load applied on the grips.

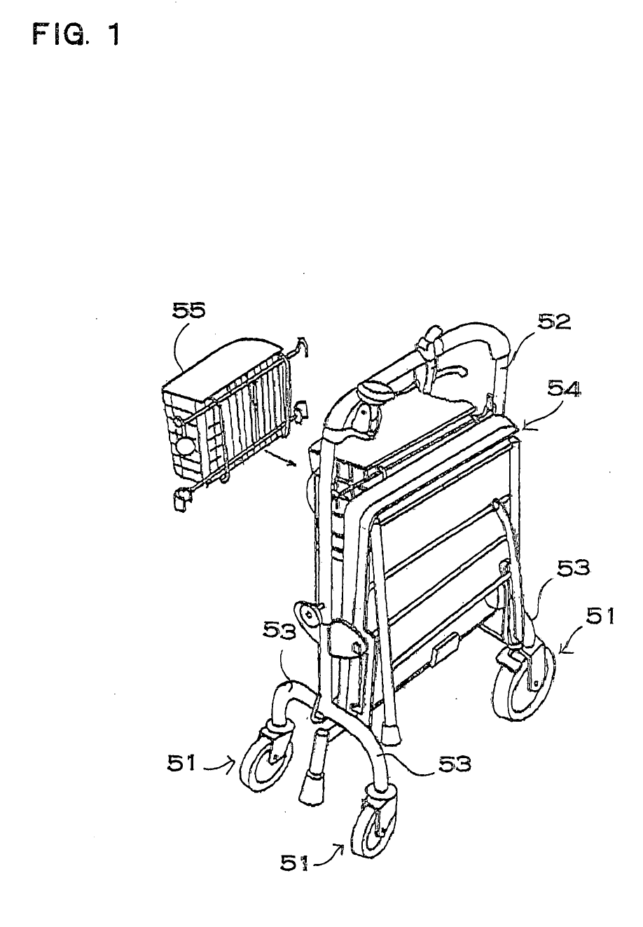

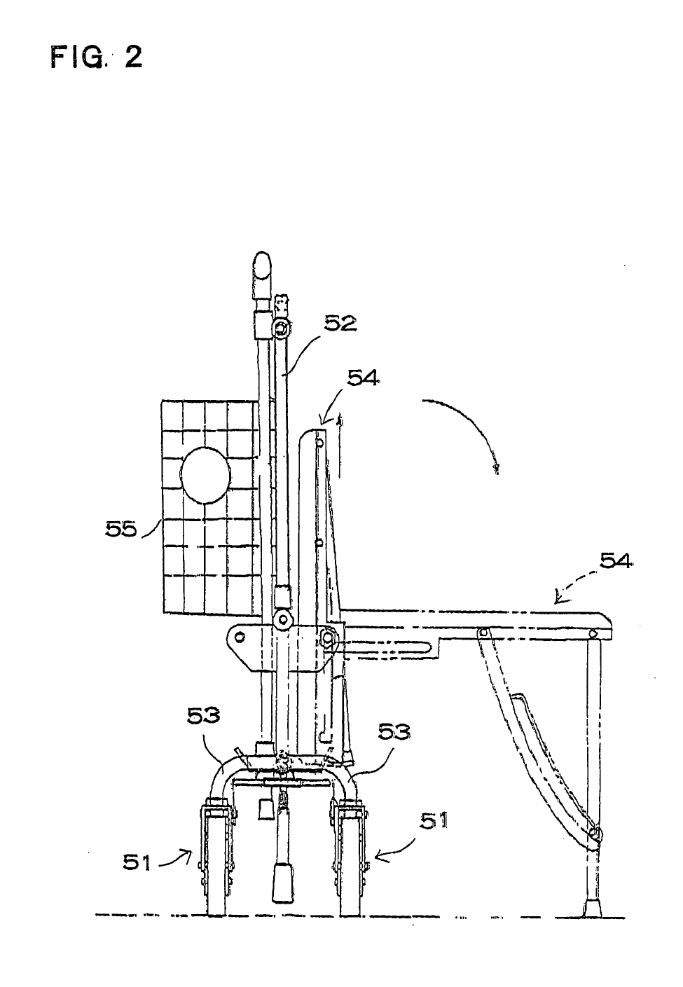

### DETAILED DESCRIPTION OF THE PREFERRED EMBODIMENTS OF THE INVENTION

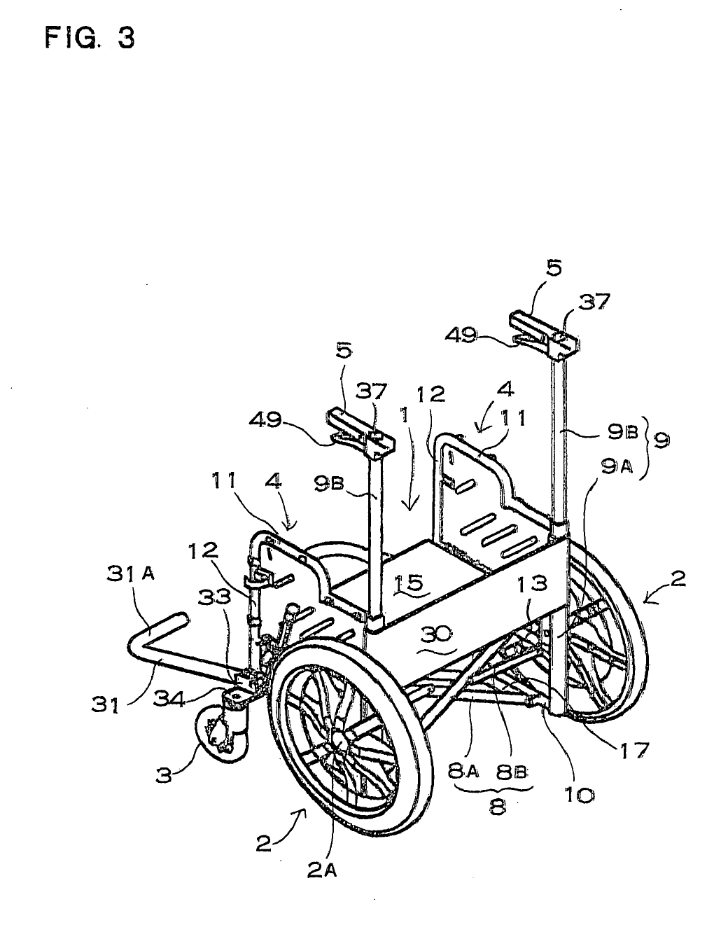

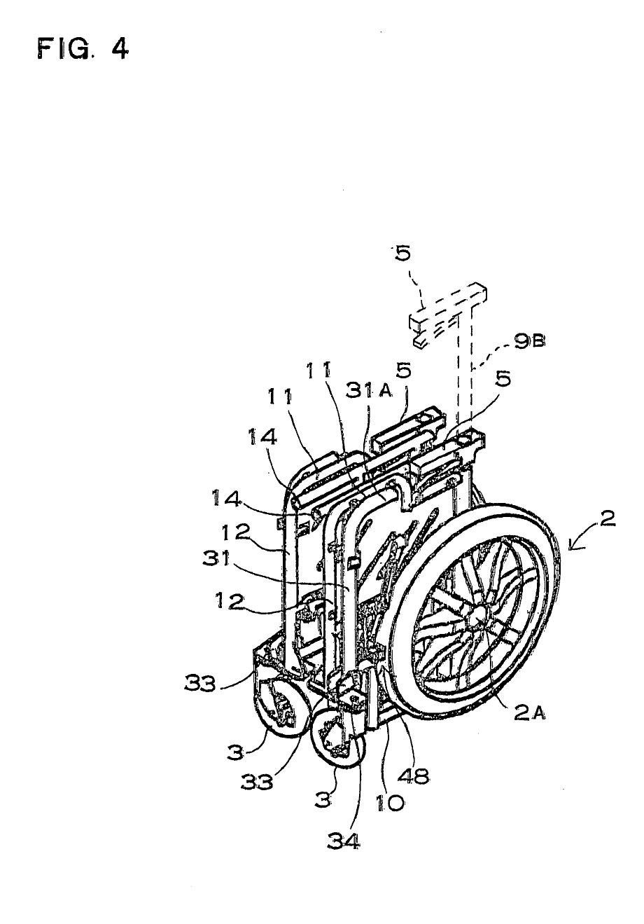

A wheelchair, which can be used as a walking stick, shown in FIGS. 3 and 4 comprises a collapsible chair 1, which has elbow rests 4 on its both sides; a pair of large wheels 2, which are rotatably attached to both the rear outsides of the collapsible chair 1; a pair of freely moving wheels 3, which can be freely moved in any moving directions and are located in both the fore sides of the collapsible chair 1; vertical rods 9, which are fastened to the rear side of the collapsible chair 1 in vertical posture; and grips 5 connected to the top ends of the vertical rods 9.

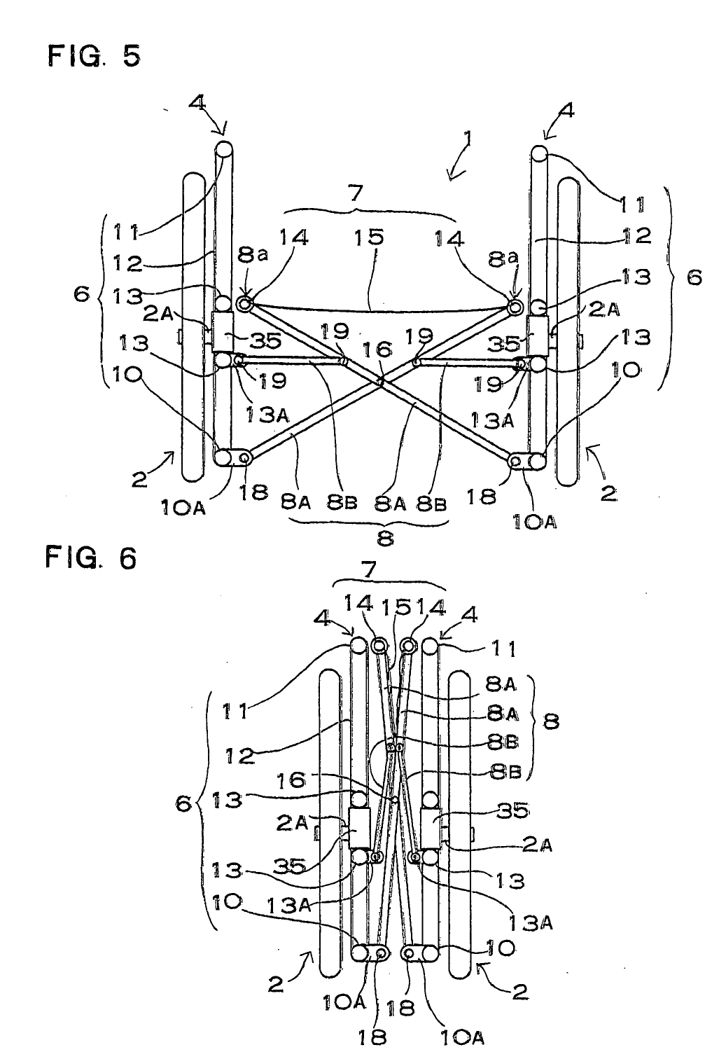

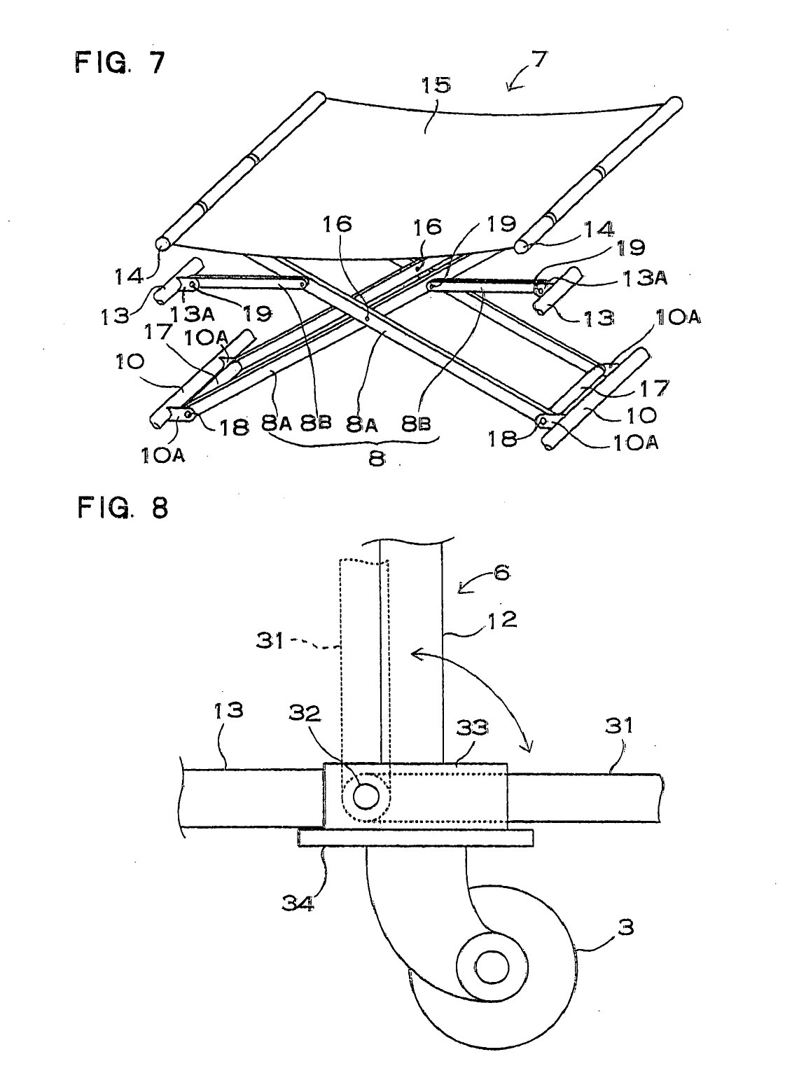

With the collapsible chair 1, its width can be narrow by collapsed so that the elbow rests 4 approach each other from the state shown in FIG. 3 to the state shown in FIG. 4. The collapsible chair 1 includes side frames 6 located on both its sides, a seat surface portion 7 used as a seat surface, and a collapsible link 8 connecting the seat surface portion 7 and the side frames 6 to each other so that they can be collapsed. FIGS. 5 and 6 are cross-sectional views schematically showing the structure of the collapsible chair 1. FIG. 7 is a perspective back view showing the seat surface portion 7 and the collapsible link 8.

In each side frame 6, the vertical rod 9 which extends vertically in the rear side, a lower frame 10 connected to the lower end of the vertical rod 9, an elbow rest frame 11 connected to the vertical rod 9, and a front frame 12 which connects the front end of the elbow rest frame 11 to the front end of the lower frame 10 are connected to each other to form a rectangular shape. In addition, in the side frame 6, intermediate frames 13 are fastened between the lower frame 10 and the elbow rest frame 11. The intermediate frame 13 is fastened in parallel to the lower frame 10. In the case of each side frame 6 of FIGS. 5 and 6, two intermediate frames 13 are provided in parallel to each other. The seat surface portion 7 includes seat surface frames 14 provided in parallel to each other on both sides, and a seat surface sheet 15 both sides of which are connected to these seat surface frames 14. The lower frames 10 and the seat surface frames 13 are pivotably connected to the ends of the collapsible link 8.

With the collapsible link 8, the side frames 6 approach each other in vertical posture, and the collapsible chair 1 is collapsed, as shown in FIGS. 4 and 6. The side frames 6 are spaced from each other, and the collapsible chair 1 is uncollapsed for use, as shown in FIGS. 3 and 5. The collapsible link 8 includes a pair of X-links 8A, and a pair of sublinks 8B, which connect the midpoints of the X-links 8A to the intermediate frames 13. The both ends of the sublink 8B are pivotably connected to the X-link 8A and the intermediate frame 13.

The X-link 8A is connected pivotably in the vertical plane at the intersectional midpoint by a pin 16. The X-link 8A is in the vertical plane. Its lower ends are pivotably connected to the lower frame 10. Its top ends are pivotably connected to the seat surface frames 14, which serve as parts of the seat surface portion 7 of the collapsible chair 1. The pair X-links 8A are spaced from each other in the front and rear direction, and are connected to the lower frames 10 and the seat surface frames 14. The lower ends of the pair of X-links 8A, which are connected to the same lower frame 10, are connected with a connection tube 17, as shown in FIG. 7. The connection tube 17 is rotatably attached to the lower frame 10. The connection tube 17 of the figure is connected pivotably in the vertical plane to protruding portions 10A, which protrude from the lower frame 10, by the pin 18. However, though not illustrated, the lower ends of the pair of X-links, which are connected to the same lower frame, may be connected with a rotational tube. In this case, the lower frame can be inserted into the rotational tube, so that the X-links are pivotably connected to the lower frame. The top ends of the pair of X-links 8A, which are connected to the same seat surface frame 14, are provided with opening through holes 8a as shown in FIGS. 5 and 6. The top ends of the pair of X-links 8A are rotatably connected by inserting the seat surface frame 14 into the through holes 8a. The X-links 8A hold the lower frames 10 and the seat surfaces frames 14 in parallel posture, when the collapsible chair 1 is collapsed by approaching the lower frame and the seat surfaces frame on one side to another side, and when it is uncollapsed by moving them away from each other.

The one end of the sublink 8B is pivotably connected to the intermediate frame 13. One end of the sublink 8B is connected pivotably in the vertical plane to a protruding portion 13A, which protrudes from the intermediate frame 13, by a pin 19. The one end of the sublink may be pivotably connected to the intermediate frame through a rotational tube. Another end of the sublink 8B is connected pivotably in the vertical plane to the midpoint in an upper half of the X-link 8A by a pin 19. The side frames 6 move so as to approach each other, or away from each other in the state where they are held in vertical posture by the sublinks 8B. Since the collapsible link 8 shown in the figure includes the pair of sublinks 8B on the right and left sides, it has an advantage that can stably hold the side frames 6 on the right and left sides in vertical posture when the collapsible chair 1 is uncollapsed.

The collapsible chair 1 of this structure is uncollapsed by moving the side frames 6 away from each other as shown in FIG. 3 and FIG. 5. In this state, the seat surface frames 14 are located above the intermediate frames 13 connected to the sublinks 8B, and the seat surface sheet 15 is spread. That is, a user can sit on the sheet. The side frames 6 spaced from each other stand in vertical posture. Both the sides of the backrest sheet 30 are connected to the vertical rods 9. When the side frames 6 are moved away from each other, the backrest sheet 30 is spread and serves as a backrest. In this state, with the collapsible chair 1, the seat surface sheet 15 and the backrest sheet 30 are spread in a plane, thus, a user can sit on the chair.

When the side frames 6 approach each other, in other words, when the elbow rests 4, which are provided in the side frames 6, approach each other, the chair is collapsed as shown in FIGS. 4 and 6. Also in this state, the side frames 6 stand in vertical posture. In this state, the wheelchair is used as a walking stick and is moved. When the chair is collapsed, the seat surface frames 14 rise to the vicinities of the elbow rest frames 11.

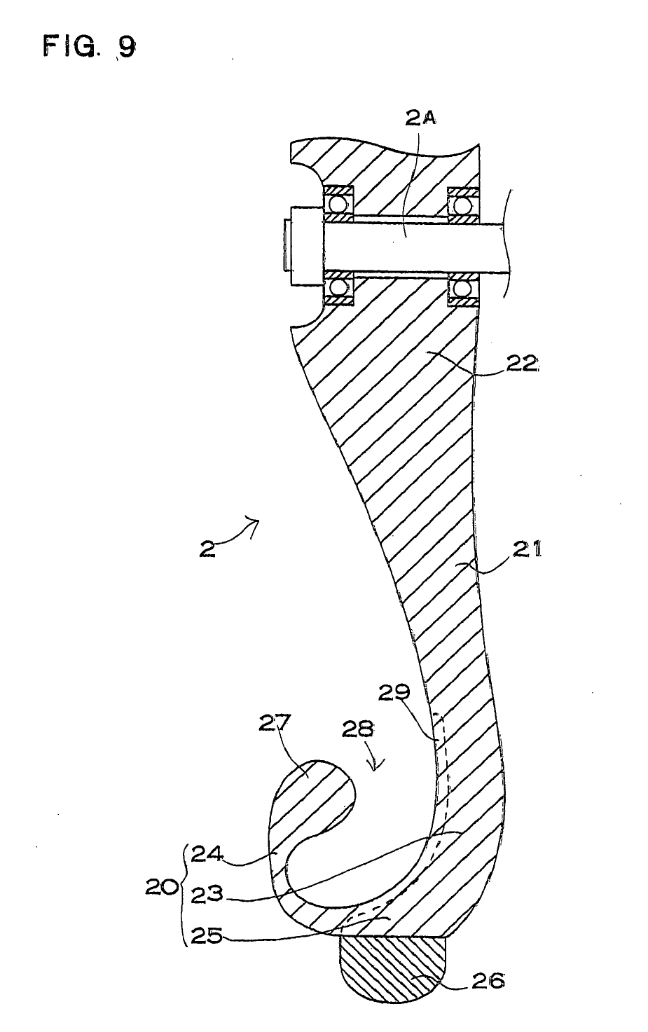

With the wheelchair of the figure, collapsible footrest frames 31 are connected to the side frames 6. The footrest frames 31 serve as a footrest on which a user sitting on the collapsible chair 1 puts user's feet. The footrest frame 31 is connected to the lower part of the side frame 6 so as to extend. FIG. 8 shows a connection portion of the footrest frame 31. The footrest frame 31 is connected to the side frame 6 through a pivot shaft 32 so as to pivot in the vertical plane from the vertical posture to the horizontal posture. The pivot shaft 32 connects the footrest frame 31 to a pair of sidewalls 33 for guiding the footrest frame 31. The footrest frame 31 is guided between the pair of sidewalls 33 in horizontal posture. The pair of sidewalls 33 are fastened onto the upper surface of the base plate 34 in parallel to each other. The footrest frame 31 is loaded onto the base plate 34 in horizontal posture, and extends frontward from the side frame 6. The fore of the footrest frame 31 is bent and serves as a footrest portion 31A. With the wheelchair of this structure, the length in the front and rear direction of the side frame 6 can be short, while a user puts his or her feet on the footrest frames 31 comfortably. When the wheelchair is collapsed, the footrest frames 31 are folded in vertical posture.

The large wheels 2 are rotatably attached to the side frames 6. In the wheelchair of the figure, a rotation shaft 2A of the large wheel 2 is connected to the vertical rod 9. A fixed plate 35 is fastened frontward of the vertical rod 9, and the rotation shaft 2A is fastened to the fixed plate 35. The fixed plate 35 is located between the two intermediate frames 13, and is fastened frontward of the vertical rod 9. The rotation shafts 2A fastened to the side frames 6 on both sides are arranged on one straight line. The reason is that the pair of large wheels 2 are positioned at the same positions of the outside of the side frames 6.

The large wheel 2 includes a peripheral rim portion 20 and a hub portion 22, which is connected to the center of the rim portion 20 through a wheel portion 21 and is rotatably connected to the rotation shaft 2A. As shown in a transverse cross-sectional view of FIG. 9, the rim portion 20 of the large wheel 2 is formed in a U-shape in a radial transverse cross-sectional view, and is composed of an inner sidewall 23 located on the collapsible chair 1 side, an outer sidewall 24 opposed to the inner sidewall 23, and a connection ring 25 connecting them. A cushion ring 26 corresponding to a tire is fastened to the peripheral surface of the connection ring 25 so that the wheelchair can smoothly move on an irregular road surface. Although the cushion ring 26 of the figure is a rubber ring, the cushion ring may have a structure, which air is put into, serving as a tire. The cushion ring 26 is fastened to the peripheral of the connection ring 25 with an adhesive. However, the cushion ring may be fitted in and connected to a groove, which is provided on the peripheral surface of the connection ring, so as not to be separated from the groove, similarly to a large wheel of a conventional wheelchair. With the rim portion 20, the inner sidewall 23 is connected to the wheel portion 21, and a grip ring 27 is located on the peripheral fore end of the outer sidewall 24. As for the large wheel 2, a user puts his or her fingers inside a U-bent portion 28, and grasps the grip ring 27, and thus rotates the large wheel 2 and moves the wheelchair.

With the large wheel 2, the interior surface of the U-bent portion 28, which is composed of the outer sidewall 24, the connection ring 25, and the inner sidewall 23, is formed as a smooth surface without an irregularity and opening, which conflict with user's hand in the direction of rotation. The large wheel 2 of the figure is provided with a smooth plate 29 formed integrally with the large wheel 2 on the interior surface of the U-bent portion 28, more specifically on the interior surface of the inner sidewall 23, and thus provides a smooth surface without an irregularity and opening, which conflict with user's hand. The large wheel 2 of this shape allows grasping the grip ring 27 for more smooth rotation. In addition, the large wheel 2 of this shape does not have a structure in which a drive ring for driving a wheel is fastened to the wheel with an arm similarly to a conventional wheel, but has the interior surface of U-bent portion 28 formed as a smooth surface without an irregularity and opening. There is no member, which conflicts with user's hand, when the user grasps the grip ring 27 and rotates the large wheel 2. The large wheel 2 of this shape has an advantage that can effectively prevent user's hand from being injured, dissimilarly to a conventional wheelchair. However, in the wheelchair of the present invention, very small irregularities or very small openings may be provided on the interior surface of the U-bent portion.

With the large wheel 2 of the figure, the rim portion 20 except the cushion ring 26, the wheel portion 21, and the hub portion 22 are integrally formed of plastic. With the large wheel 2 of the figure, the wheel portion 21 is composed of radial rods, the both ends of which are connected to the hub portion 22 and the rim portion 20, respectively. The wheel portion 21 may be formed in a disc shape as a whole. With the large wheel, the rim portion, which is composed, of the inner sidewall, the outer sidewall, the connection ring, and the smooth plate may be integrally formed of plastic. In this case, the rim portion can be connected to the hub portion through the wheel portion separately formed from the rim portion.

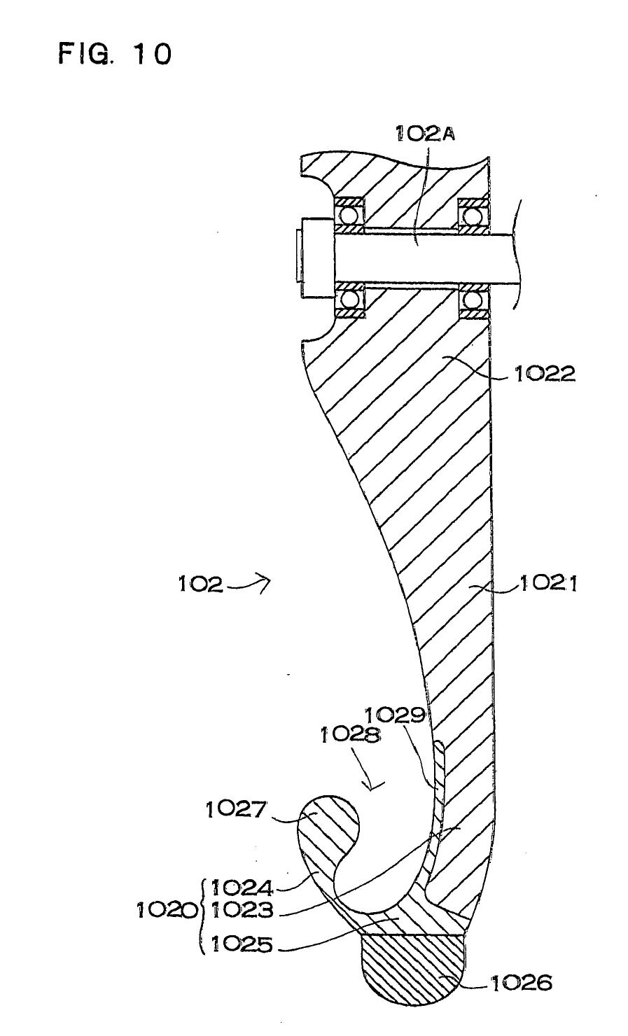

With the large wheel 2 of the figure, the peripheral fore end of the outer sidewall 24 of the rim portion 20 is bent inward of the U-bent portion 28, thus, the grip ring 27 is provided in the opening of the U-bent portion 28. In the rim portion 20 of this structure, a user puts the fore of his or her fingers in the opening deeply, can firmly grasp the grip ring 27, and rotates the large wheel 2. However, as shown in FIG. 10, the rim portion of the large wheel may be provided with an outer sidewall 1024 formed in posture that extends in the vertical direction. In this case, a grip ring 1027 is located at the peripheral fore end of the outer sidewall 1024.

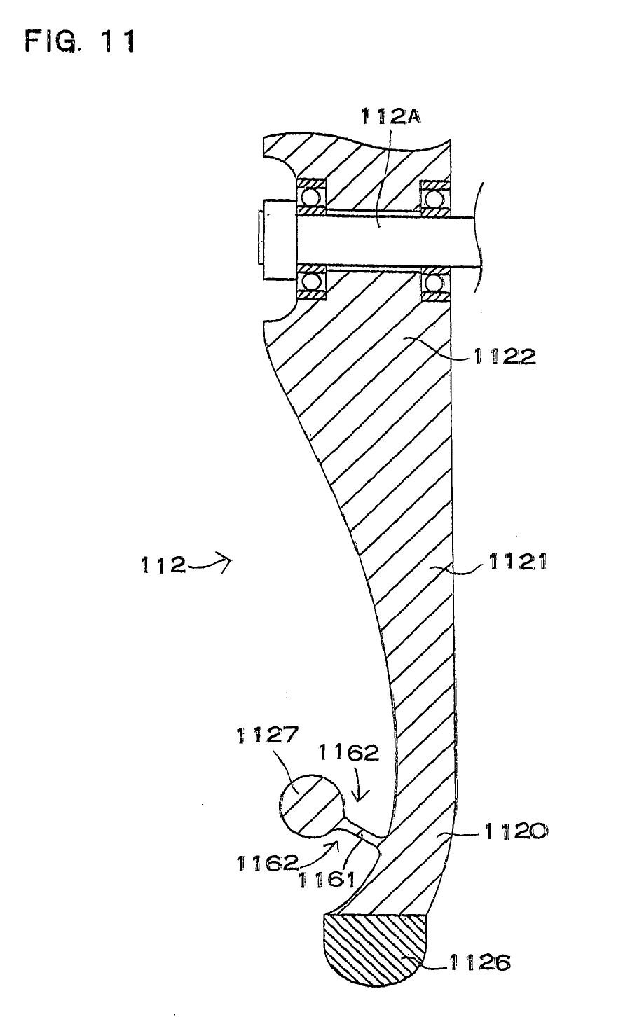

The large wheel may have the structure shown in FIG. 11. In a large wheel 112 shown in this figure, a connection wall 1161 is located on the lateral surface of a rim portion 1120, and a grip ring 1127 is located at the peripheral fore end of the connection wall 1161. The connection wall 1161 is formed in a ring shape, which is located along the perimeter of the rim portion 1120. The connection wall 1161 protrudes at the position located slightly radial-inward of the perimeter of the rim portion 1120. The connection wall 1161 is also formed as a smooth surface without an irregularity and opening, which conflict with user's hand in the direction of rotation. The connection wall 1161 is thinner than the grip ring 1127. Grip recessed portions 1162 for easily grasping the grip ring 1127 are provided on the both sides of the connection wall 1161 between the grip ring 1127 and the rim portion 1120. In order to easily grasp the grip ring 1127, the connection wall 1161 of the figure extends in the direction that inclines slightly radial-inwardly from perimeter side of the rim portion 1120. The large wheel 112 also has an advantage that allows grasping the grip ring 1127 for more smooth rotation.

With the large wheel 2, 102, and 112 of FIGS. 9 to 11, the wheel portions 21, 1021, and 1121 are formed so that their surfaces are curved toward the axially outside from the axially inside that is close to the collapsible chair 1 as closer to the hub portions 22, 1022, and 1122 from the rim portions 20, 1020, and 1120, in other words, as closer to the center from their perimeters. The large wheels 2, 102, and 112 have a shape for easily grasping the grip rings 27, 1027, and 1127, and have an advantage that can reduce their widths as a whole. Accordingly, in the wheelchairs which can reduce their widths of the large wheels 2, 102, and 112, since the whole widths of the wheelchairs can be reduced, the wheelchairs can be very functionally moved even in narrow places, such as the inside of vehicle or a rest room. Besides, in the large wheels of FIGS. 10 and 11, components same as or similar to those of the large wheel shown in FIG. 9 are attached with numerals with the same last digit(s) of reference numerals in FIG. 9 except the first two digits of numerals and their description is omitted.

The freely moving wheel 3 is fastened to the front of the lower frame 10. In the wheelchair of the figure, the freely moving wheel 3 is fastened to the base plate 34 of the footrest frame 31.

The vertical rods 9 are fastened to the rear side of the collapsible chair 1 in vertical posture. With, the wheelchair of the figure, the backrest sheet 30 is fastened to the vertical rod 9, thus the vertical rod 9 is used as a backrest. The vertical rods 9 are extensible rods, which include stoppers 36 capable of holding that the vertical rods 9 are extended. The height of the grips 5 is 60 to 100 cm as a whole in the state where the vertical rods 9 are extended. The extensible vertical rod 9 includes a fixed rod 9A, which the backrest sheet 30 is fastened to, and an extensible rod 9B extensibly inserted into the fixed rod 9A.

The stopper 36 can hold that the extensible rod 9B is raised from the fixed rod 9A. The stopper 36 is provided with a disengaging button 37, which disengages the holding, in the grip 5. With the wheelchair of FIG. 3, the disengaging buttons 37 are located on the upper surfaces of the grips 5. With this wheelchair, when the disengaging button 37 of the grip 5 is pressed, the vertical rod 9 can be retracted. In other words, when not pressed, the disengaging button 37 holds that the vertical rod 9 is extended.

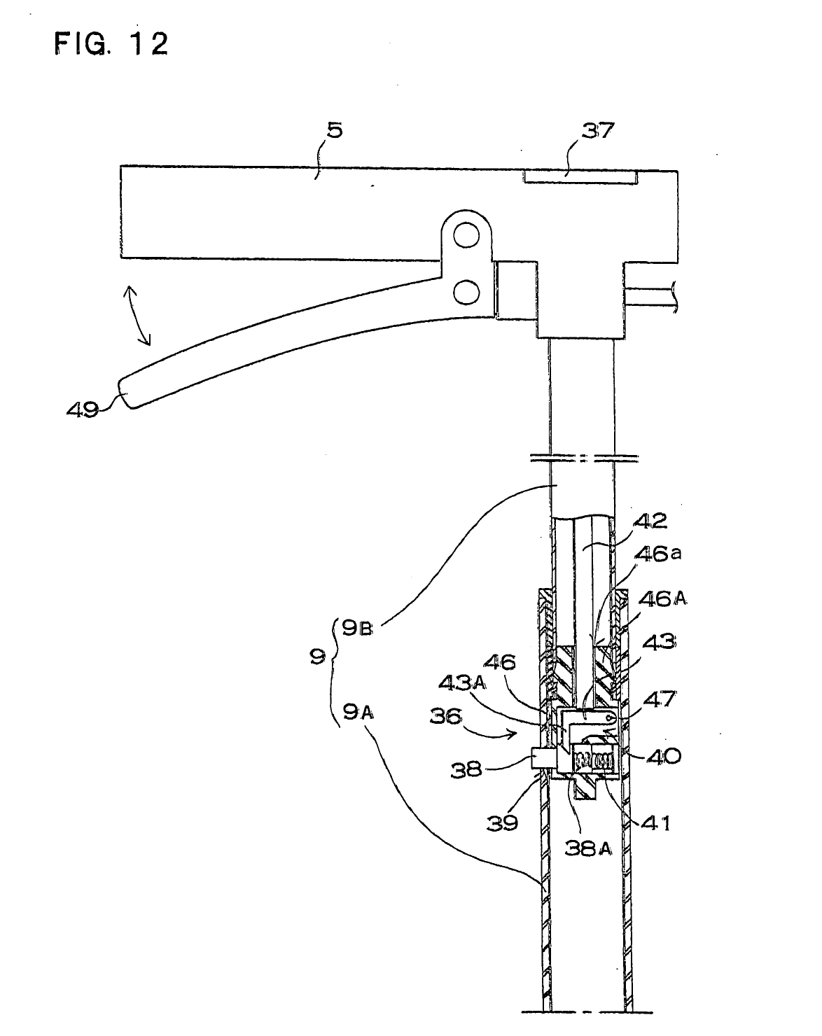

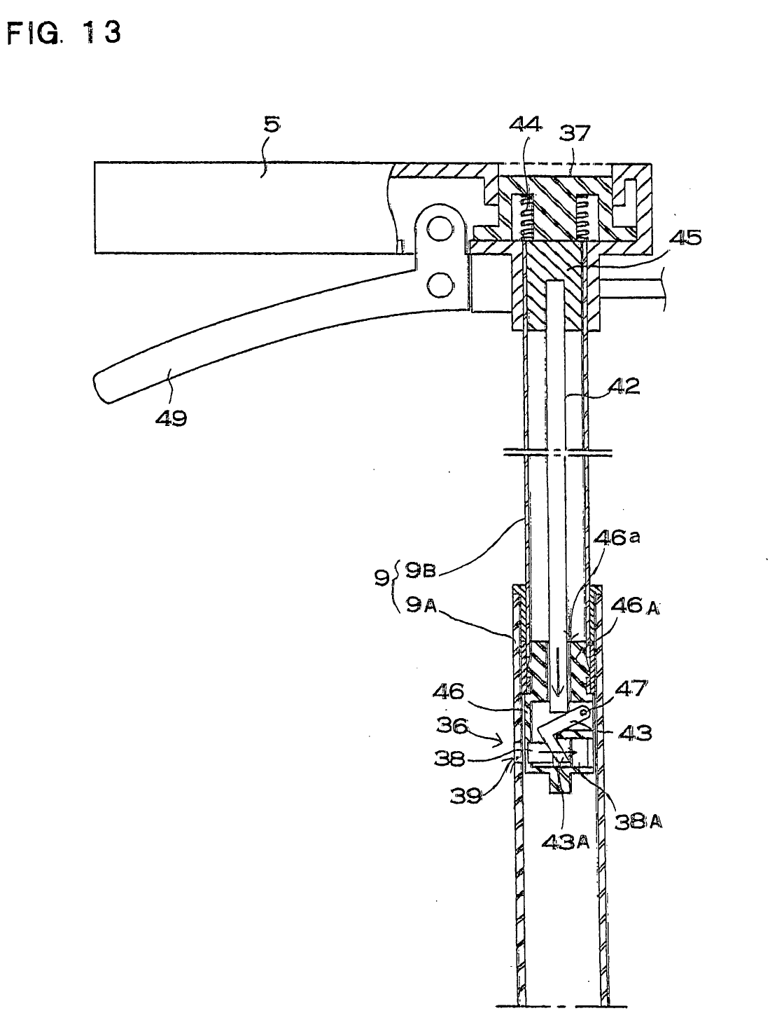

Any mechanism capable of holding that the vertical rod 9 is extended/retracted can be used as the stopper. One example of the internal mechanism of the stopper are shown in FIGS. 12 and 13. The stopper 36 of figures includes a protruding pin 38 which is located in the lower end of the extensible rod 9B and elastically protrudes toward a fixed rod 9A; a receiving portion 39 which is located in the fixed rod 9A and receives the protruding pin 38 inserted thereto; and a disengaging mechanism 40, which forcedly retracts the protruding pin 38 from the receiving portion 39.

The protruding pin 38 is attached to the lower end side of the extensible rod 9B through an elastic member 41 so as to elastically protrude toward the fixed tube 9A. The protruding pin 38 elastically protrudes from the extensible rod 9B by being thrust by the elastic member 41. The receiving portion 39 is a through hole or a recessed portion into which the protruding pin 38 is inserted. The fixed rod 9A shown in the figure has a through hole opening thereon, into which the protruding pin 38 is inserted, as the receiving portion 39. The structure with the through hole as the receiving portion 39 has an advantage that can ensure to secure the extensible rod 9B by protruding the protruding pin 38 outwardly of the fixed rod 9A through the hole. This can provide extreme safety in use of the extensible rods 9B instead of a walking stick, in other words, when a user leans on the grip 5 to support his or her weight. The reason is that the extensible rods 9B can be effectively prevented from being pushed down due to unintentional disengagement of the protruding pin 38 from the receiving portion 39. In addition, the structure has another advantage that can prevent the extensible rods 9B from extending unintentionally when a user lifts the whole wheelchair with grasping the grip 5. Thus, the stopper 36 capable of surely securing the position of the extensible rod 9B has an advantage that provides extreme safety in use in the case of the grip 5 at the raised position and lowered position. However, the receiving portion may be a recessed portion into which a tip of the protruding pin is inserted.

The receiving portions 39 provided in the fixed rod 9A are provided at the positions into which the protruding pin 38 is inserted in the states where extensible rod 9B is raised and lowered. When the extensible rod 9B is raised, the protruding pin 38 is inserted into the upper receiving portion 39. On the other hand, when extensible rod 9B is lowered, the protruding pin 38 is inserted into the lower receiving portion 39. Thus, the extensible rod 9B is not extended/retracted. However, the vertical rod can be provided with an additional receiving portion in the middle position, thus, the extensible rod can be extended/retracted in multi steps. Particularly, in the structure that has a plurality of receiving portions in the middle of the fixed rod, the extensible rod, which is raised in the middle, can be held at one of a plurality of raised positions. This structure has an advantage that can select the optimal position by raising and lowering the position of the grip in a stepped manner.

The disengaging mechanism 40 includes the disengaging button 37 located in the grip 5, a drive rod 42 which is connected to the disengaging button 37 and is vertically moved by the disengaging button 37, and a pivot member 43 which pivots so as to forcedly retract the protruding pin 38 inward by being pushed by the lower end of the drive rod 42.

The disengaging button 37 is provided on the upper surface of the grip 5, above the extensible rod 9B, so as to move vertically. The disengaging button 37 is connected to the lower surface of the grip 5 through an elastic member 44, and is elastically thrust through the elastic body 44. The lower surface of the disengaging button 37 is connected to the drive rod 42, and drives the drive rod 42 vertically when the disengaging button 37 is moved by user's finger or thumb.

The drive rod 42 is positioned inside the grip 5 and the extensible rod 9B, and is driven to pivotally move the pivot member 43 by the disengaging button 37. The upper end of the drive rod 42 shown in the figure is inserted into an insertion cap 45, which vertically moves inside the extensible rod 9B. Thus, the drive rod 42 can accurately move inside the extensible rod 9B in the vertical direction. The lower end of the drive rod 42 extends to the lower end of the extensible rod 9B.

The pivot member 43 is connected to the lower end of the extensible rod 9B, and pivots in the direction that forcedly moves the protruding pin 38 inwardly by pushed by the lower end of the drive rod 42. The lower end of the extensible rod 9B shown in the figure is connected to a guide cap 46. The pivot member 43 is attached inside the guide cap 46 so as to pivot in the vertical plane. The guide cap 46 has a connection cylindrical portion 46A, which is inserted into the extensible rod 9B, in the upper part, so that the lower part of the drive rod 42 can accurately move in the vertical direction. The connection cylindrical portion 46A is provided with an opening insertion hole 46a into which the drive rod 42 is inserted. One end of the pivot member 43 is connected to the guide cap 46 via a pivot shaft 47, and a pin 43A protruding toward the protruding pin 38 is located at both sides of another end. When the pivot member 43 pivots by being thrust by the drive rod 42, the tip of the pin 43A comes in contact with protruding portions 38A provided on both sides of the protruding pin 38, and then the pivoting pin 43A thrusts the protruding pin 38 so as to forcedly retract the protruding pin 38. When thrust of the drive rod 42 is released, the protruding pin 38 is not thrust by the pin 43A of the pivot member 43, thus, the pivot member 43 pivots in a rest position by being elastically pushed by the elastically member 41.

In the above disengaging mechanism 40, when the disengaging button 37 is pressed, the drive rod 42 is pushed downward, and the pivot member 43, which is provided on the lower end of the drive rod 42, pivots. The pivot member 43 moving pivotally moves the protruding pin 38 in the direction that the protruding pin 38 is retracted away with the tip of the pin 43A, and retracts the protruding pin 38 away from the receiving portion 39. In this state, the stopper 36 is disengaged, and the extensible rod 9B can vertically move inside the fixed rod 9A. When the disengaging button 37 is released, the protruding pin 38 can protrude toward the fixed rod 9A by being thrust by the elastic member 41.

In the stopper 36, pushing the disengaging button 37 provided on the grip 5 forcedly moves the protruding pin 38 inward, thus, the stopper 36 is disengaged. The extensible rod 9B is raised or lowered in the state of disengagement of the stopper 36. The extensible rod 9B with the protruding pin 38 retracted therein can vertically move inside the fixed rod 9A. After the disengaging button 37 is released, when the grip 5 is adjusted to a predetermined height, the protruding pin 38 is led to the receiving portion 39, thus, the extension and retraction of the extensible rod 9B stop. Accordingly, upward and downward movement of the grip 5 also stops.

The stopper 36 of the above structure has a simple structure and can secure the extensible rod 9B at the predetermined positions. However, in the wheelchair according to the present invention, the stopper is not specifically limited to the above structure. Any mechanism capable of securing the extensible rod at a predetermined position can be used as the stopper.

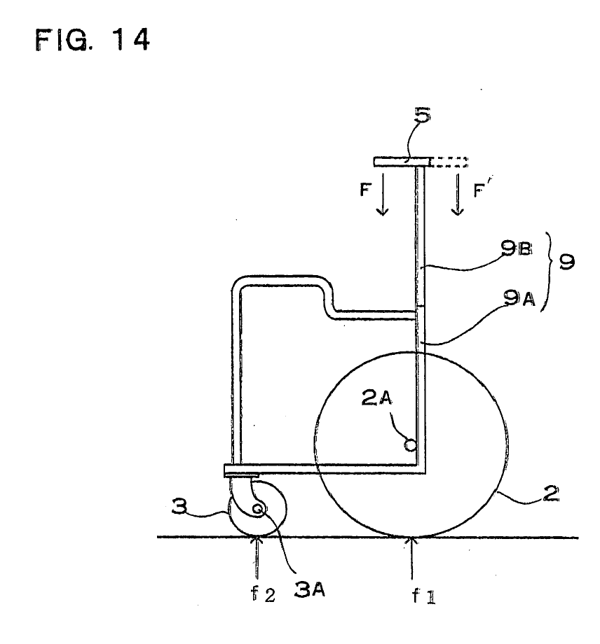

The grips 5 are fastened so as to extend frontwardly from the top ends of the vertical rods 9 in the state where at least their fore ends are positioned frontward of the rotation shafts 2A of the pair of large wheels 2 and rearward of the rotation shafts 3A of the freely moving wheels 3. The reason for positioning the grips 5 in this arrangement is to apply the vertical load (F), which acts on the wheelchair, between the point where the vertical load (f1) of the large wheel 2 is applied and the point where vertical load (f2) of the freely moving wheel 3 is applied, as shown in FIG. 14. The vertical loads of the large wheel 2 and the freely moving wheel 3 act on their surfaces in contact with the ground. Since the wheelchair moves on level ground in the most cases, the surfaces in contact with the ground lie directly under the rotation shafts 2A and 3A. Accordingly, the fore of the grip 5 is located between the rotation shaft 2A of the large wheel 2 and the rotation shaft 3A of the freely moving wheel 3. The whole grip 5 is located between the rotation shaft 2A of the large wheel 2 and the rotation shaft 3A of the freely moving wheel 3, or the fore of the grip 5 is located between the rotation shaft 2A of the large wheel 2 and the rotation shaft 3A of the freely moving wheel 3. With the grip 5 positioned in this arrangement, the vertical load (F), which acts on the grip 5, acts on the large wheel 2 and the freely moving wheel 3 in balance. If a grip is located rearward than the large wheel as shown by a dashed line of FIG. 14, the vertical load (F′), which acts on the grip, acts rearward than the large wheel. This produces turning moment that pushes the wheelchair down rearward. Accordingly, when this force is large, the wheelchair is pushed down rearward. However, in the case where the vertical load (F) acts between the large wheel 2 and the freely moving wheel 3, even when very large force is applied, the turning moment that pushes the wheelchair down is not produced. Therefore, the wheelchair is not pushed down.

The grips 5 are provided with levers 49 for operating brakes 48 provided on the large wheels 2. When walking on a slope, a user acts the brakes on the large wheels 2 by grasping the levers 49 of the grips 5. Accordingly, a user can safely move with braking the wheelchair.

As this invention may be embodied in several forms without departing from the spirit or the essential characteristics thereof, the present embodiment is therefore illustrative and not restrictive, since the scope of the invention is defined by the appended claims rather than by the description preceding them, and all changes that fall within the metes and bounds of the claims, or the equivalence of such metes and bounds thereof are therefore intended to be embraced by the claims. This application is based on applications No. 2003-323718 filed in Japan on Sep. 16, 2003, the content of which is incorporated hereinto by reference.

1. A wheelchair usable as a walking stick comprising:
a collapsible chair which can be collapsed in the direction that both its sides approach each other;
a pair of large wheels which are rotatably attached to both the outsides of the collapsible chair;
a pair of freely moving wheels which can be freely moved in any moving directions and are located in both the fore sides of the collapsible chair;
vertical rods which are fastened to the collapsible chair in vertical posture; and
grips, which are fastened so as to extend frontward at the top ends of the vertical rods, with at least their fore ends positioned frontward of the rotation shafts of the pair of large wheels and rearward of the freely moving wheels, wherein
the wheelchair can be moved as a walking stick by grasping the grips, and rotating the large wheels and the freely moving wheels in the state where the collapsible chair is collapsed.

2. The wheelchair usable as a walking stick according to claim 1, wherein the vertical rods are extensible.

3. The wheelchair usable as a walking stick according to claim 2, wherein the wheelchair comprises a stopper which can hold that the vertical rods are extended.

4. The wheelchair usable as a walking stick according to claim 1, wherein the height of the grips is 60 to 100 cm in the state where the vertical rods are extended.

5. The wheelchair usable as a walking stick according to claim 1, wherein a brake is provided on the large wheel, and the grip has a lever for operating the brake.

6. The wheelchair usable as a walking stick according to claim 1, wherein the vertical rod is located in the position that extends upward from the rotation axis of the large wheel.

7. The wheelchair usable as a walking stick according to claim 1, wherein a collapsible chair has elbow rests on both its sides, and its width can be narrow by collapsed so that the elbow rests approach each other.

8. The wheelchair usable as a walking stick according to claim 1, wherein the collapsible chair includes side frames located on both its sides, a seat surface portion used as a seat surface, and a collapsible link connecting the seat surface portion and the side frames to each other so that they can be collapsed.

9. The wheelchair usable as a walking stick according to claim 8, wherein the large wheels are rotatably connected to the side frames.

10. The wheelchair usable as a walking stick according to claim 1, wherein the rotation shaft of the large wheel is connected to the vertical rod.

11. The wheelchair usable as a walking stick according to claim 10, wherein a fixed plate is fastened frontward of the vertical rod, and the rotation shaft of the large wheel is fastened to the fixed plate.

12. The wheelchair usable as a walking stick according to claim 1, wherein the large wheel includes a peripheral rim portion and a hub portion, which is connected to the center of the rim portion through a wheel portion and is rotatably connected to the rotation shaft, wherein the rim portion is formed in a U-shape in a radial transverse cross-sectional view, and is composed of an inner sidewall located on the collapsible chair side, an outer sidewall opposed to the inner sidewall, and a connection ring connecting them.

13. The wheelchair usable as a walking stick according to claim 1, wherein the vertical rods which are fastened to the rear side of the collapsible chair in vertical posture.

14. The wheelchair usable as a walking stick according to claim 1, wherein the vertical rod is used as a backrest by fastening a backrest sheet to the vertical rod.

15. The wheelchair usable as a walking stick according to claim 14, wherein the vertical rod is extensible, and includes a fixed rod, which the backrest sheet is fastened to, and an extensible rod extensibly inserted into the fixed rod.

16. The wheelchair usable as a walking stick according to claim 15, wherein the wheelchair comprises a stopper which can hold that the extensible rod is pulled up from the fixed rod.

17. The wheelchair usable as a walking stick according to claim 16, wherein the stopper is provided with a disengaging button, which disengages the holding, in the grip.

18. The wheelchair usable as a walking stick according to claim 17, wherein the stopper includes a protruding pin which is located in the lower end of the extensible rod and elastically protrudes toward the fixed rod; a receiving portion which is located in the fixed rod and receives the protruding pin inserted thereto; and a disengaging mechanism, which forcedly retracts the protruding pin from the receiving portion.

19. The wheelchair usable as a walking stick according to claim 18, wherein the disengaging mechanism includes the disengaging button located in the grip, a drive rod which is connected to the disengaging button and is vertically moved by the disengaging button, and a pivot member which pivots so as to forcedly pull the protruding pin inward by being pushed by the lower end of the drive rod.

20. The wheelchair usable as a walking stick according to claim 1, wherein the whole grip is located between the rotation shaft of the large wheel and the rotation shaft of the freely moving wheel.
